(19) United States
(12) Patent Application Publication
(10) Pub. No.: US 2006/0283887 A1
(43) Pub. Date: Dec. 21, 2006

(54) Up-lock seal for dispenser pump

(76) Inventors: Rowshan Jahan, Fort Wayne, IN (US); David VanZuilen, Fremont, IN (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/331,598

(22) Filed: Jan. 13, 2006

Related U.S. Application Data
(60) Provisional application No. 60/644,387, filed on Jan. 14, 2005.

(51) Int. Cl. B67D 5/58

(52) U.S. Cl. 222/190; 222/135

(57) ABSTRACT

Current designs of dispensers often do not allow for proper ventilation. Additionally, current designs often do not permit proper liquid sealing during shipment. The disclosed apparatus can overcome these shortcomings. This foam dispenser comprises a container, a cylinder device, a collar connected to the cylinder device, the collar operably connecting the container with the cylinder device, and a seal located on the collar, wherein the seal expands under compression to a locked position to create an airtight and liquid tight seal substantially preventing air and liquid from entering or exiting the cylinder device.

### CROSS-REFERENCE TO RELATED APPLICATIONS

This application claims priority from U.S. Provisional Patent Application No. 60/644,387 filed on Jan. 14, 2005, which is hereby incorporated by reference.

### FIELD OF THE INVENTION

The present invention relates generally to hand-operated dispensers, and, more particularly, to foamer dispensers having a seal to create an airtight and liquid tight seal substantially preventing air and liquid from entering or exiting the dispenser.

### BACKGROUND

Over the last 15 years or so the use of foam dispensers based on aerosols using pressurized gas has declined steeply for environmental reasons. This has lead to the development of foaming dispensers that exploit a manual pumping action to blend air and liquid to create foam.

A particular category of such known dispensers, also known as foaming dispensers or foamers, provides both a liquid pump and an air pump mounted at the top of a container. The liquid pump has a liquid pump chamber defined between a liquid cylinder and a liquid piston, and the air pump has an air pump chamber defined between an air cylinder and an air piston. These components are typically arranged concentrically around a plunger axis of the pump. The liquid piston and air piston are reciprocal in their respective cylinders by the action of a pump plunger. Typically the two pistons are integrated with the plunger. An air inlet valve and a liquid inlet valve are provided for the air chamber and liquid chamber. An air discharge passage and a liquid discharge passage lead from the respective chambers to an outlet passage by way of a permeable foam-generating element, normally one or more mesh layers, through which the air and liquid pass as a mixture. Preferably the air discharge passage and liquid discharge passage meet in a mixing chamber or mixing region immediately upstream of the permeable foam-generating element.

Current designs of dispenser pumps do not allow for proper ventilation to the mating bottle in a pump and bottle system. The failure to achieve proper ventilation prevents vacuum build-up inside the mating liquid bottle as liquid is pumped out of the liquid bottle. In addition, current designs do not permit proper liquid sealing during shipment. Often, the liquid in the liquid bottles will leak out during transportation wasting the liquid and creating an undesirable mess.

### SUMMARY OF THE INVENTION

Accordingly, a foam dispenser is disclosed herein. This foam dispenser comprises a container, a cylinder device, a collar connected to the cylinder device, the collar operably connecting the container with the cylinder device, and a seal located on the collar, wherein the seal expands under compression to a locked position to create an airtight and liquid tight seal substantially preventing air and liquid from entering or exiting the cylinder device.

Another embodiment discloses a foam dispenser that comprises a container, a cylinder device, a collar connected to the cylinder device to operably connect the container with the cylinder device, a plunger, at least a portion of which is mounted within the cylinder device, and a seal located within the collar and engageable with the plunger, wherein the seal is capable of being opened to vent the cylinder device and the container and is capable of being closed to substantially prevent air or liquid from entering or exiting the cylinder component.

In yet another embodiment, a foam dispenser comprises a container, a cylinder device, a collar connected to the cylinder device, the collar operably connecting the container with the cylinder device, a plunger, wherein at least a portion of the plunger is mounted within the cylinder device, and a seal located on the collar, the seal comprising, an inclined wall, and a cam capable of engaging the plunger with the inclined wall to substantially prevent air or liquid from entering or exiting the cylinder device and the container.

### DESCRIPTION OF THE DRAWINGS

The operation of the foam dispenser disclosed herein may be better understood by reference to the following detailed description taken in connection with the following illustrations, wherein:

FIG. 1 is a diagrammatical view of an embodiment of a foam dispenser;

FIG. 2 is a diagrammatical view of the dispenser of the present embodiment without the bottle portion;

FIG. 3 is a more detailed diagrammatical view of the dispenser of FIG. 2;

FIG. 4 is a first perspective view of the spout and collar of the dispenser; and

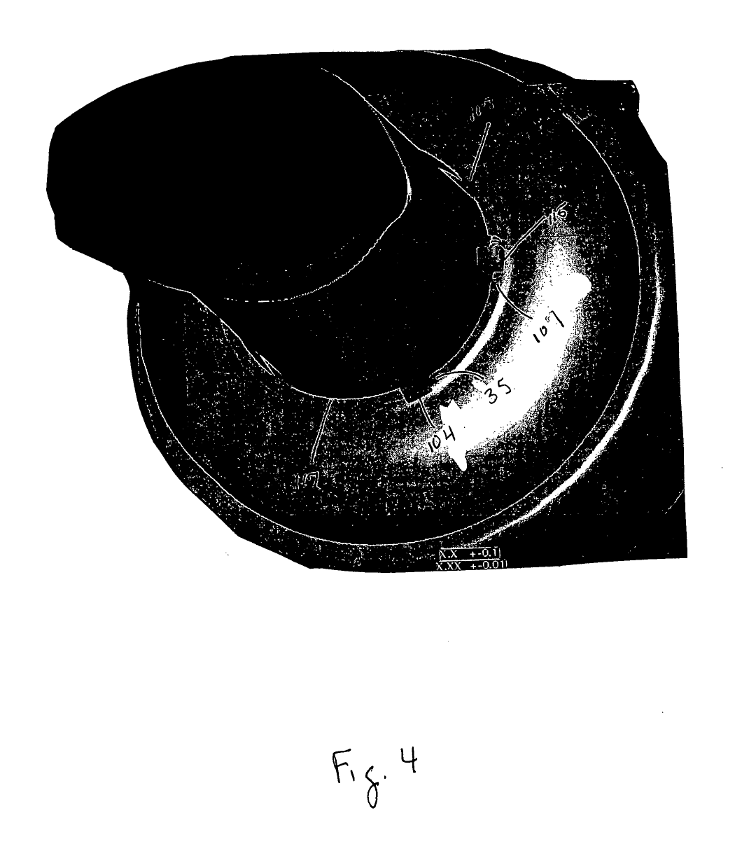

FIG. 5 is a second perspective view of the spout and collar of the dispenser.

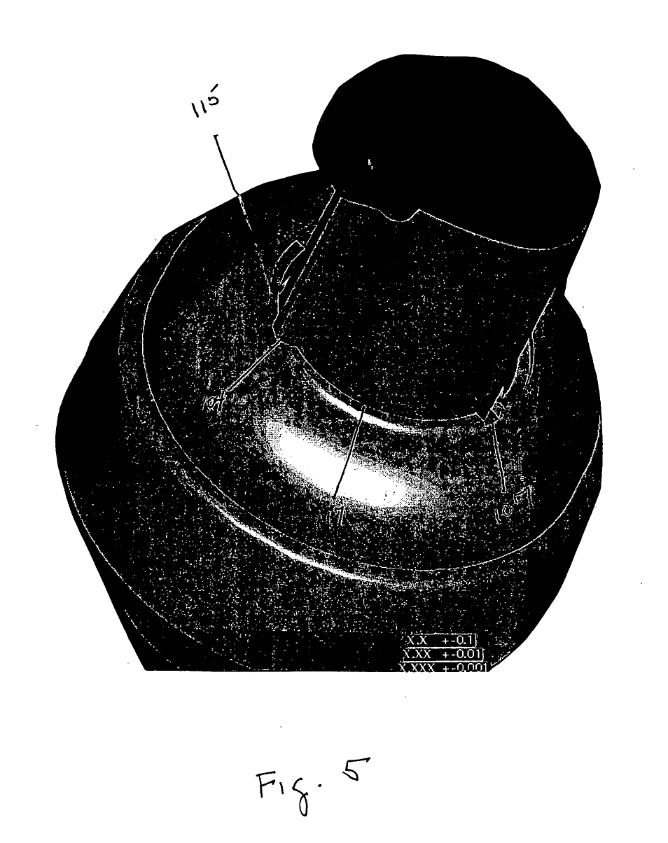

### DETAILED DESCRIPTION

As shown in the accompanying drawings, a hand-operated foam dispenser 1 is shown. The dispenser 1 is mounted on the threaded neck 15 of a conventional blow-molded cylindrical container or bottle 10. The container or bottle 10, however, need not be cylindrical. It can take any sort of shape. The dispenser 1 further includes a cylinder device 20 made of material such as polypropylene, and may be of a one-piece construction or multiple-piece construction. The cylinder device 20 includes a lower, smaller-diameter liquid cylinder 25 and an upper larger-diameter air cylinder 30. The cylinder device 20 is recessed down into the neck 15 of the container 10 and held in place by a threaded retaining collar 35. In particular, the collar 35 connects to the cylinder device 20 to operably connect the container 10 with the cylinder device 20. Finally, the dispenser 1 may include an overcap 36. The overcap 36 engages the collar 35 so as to retain the overcap 36 in place and prevent it from falling off.

The liquid cylinder 25 further includes a liquid chamber 26. At the bottom end of the liquid cylinder 25 a valve seat 38 is integrally formed, although it may also be non-integrally connected therewith. A valve ball 39 is seated with in the valve seat 38. In the current embodiment, the valve ball 39 is a 4 mm ball, but could be of different sizes depending upon the size of the valve seat 38. Finally, a dip tube or suction pipe 37 is connected to the liquid cylinder 25, or may be integrally formed therewith. The suction pipe 37 draws the liquid from the bottle 10 into the liquid chamber 26.

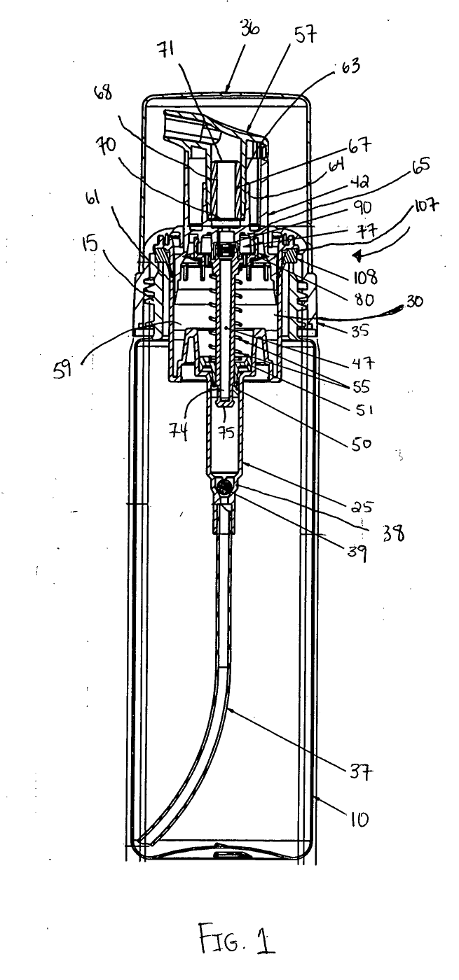

The cylinder device 20 includes a plunger 42 that is mounted to act reciprocally in the air and liquid cylinders 30, 25. As can be seen in FIG. 1, at least a portion of the plunger 42 is mounted within the cylinder device 20. The plunger 42 includes an integrated cap shroud 45, a projecting central stem, or more specifically, a piston 47, carrying a piston seal 50 that works in the liquid cylinder 25. A tubular piston-retaining insert 51 is snapped into the base of the air cylinder 30 and the liquid piston seal 50 is trapped beneath it. This keeps the plunger 42 in the assembly. A return spring 55 is fitted around the plunger stem 47, and acts to urge the plunger 42 to its uppermost position. Finally, the plunger 42 includes a spout 57 through which the foamed liquid is dispensed to the operator when such operator uses the foaming dispenser 1 as more specifically described below.

The air cylinder 30 includes an air chamber 59 and an air piston 61 that surrounds the upper part of the plunger stem 47. It is retained by a snap fit engagement into the lower end of the cap shroud 45 of the plunger 42. This cap shroud 45 is of substantially the same diameter as the air cylinder 30. Pressing down the plunger 42 directly (without play or lost motion) operates the air piston 61 in its cylinder 30.

Considering now the central parts of the plunger 42, the spout 57 communicates with an inner axial downwardly-open tube 63 that forms a top foamer unit housing. This tube 63 snap fits into an upwardly-open cylindrical tube 64 of a core insert component 65, trapping in the space between them a foam-generation element 67 in the passage leading to the spout 57. This foam-generating element 67 has a cylindrical plastic tube 68 fitting closely in the housing tube 63 and having ultrasonically welded across its open ends a disk of coarse nylon mesh 70 (bottom end) and fine nylon mesh 71 (top end).

It will be noted that in the current embodiment the piston seal 50 of the liquid piston is of the “sliding seal” type that acts as a discharge valve at the entrance to the liquid discharge passage 74. That is to say, on the downstroke of the plunger 42 the sliding seal 50 is displaced upwardly relative to the plunger stem 47 and uncovers the plunger stem windows 75. This allows liquid to flow under pressure from the liquid pump chamber 26 into the liquid discharge passage 74 and through the foam-generating element 67 to create the foamed liquid.

The action of the pump on pressing down the plunger is as follows. At the same time as liquid is driven up passage 74 as mentioned, air in the air chamber 61 is forced—by the decrease in volume of that chamber—through an air outlet valve 77 into the air discharge chamber and radially in from all directions to mix vigorously with the rapid and distributed upflow of liquid. The liquid and air flows mix as they enter the foam generating element 67 when they pass through the progressively decreasing meshes 70, 71 and merge as foam from the spout 57. The one-way action of the air inlet valve flap 80 prevents escape of air from the chamber 61 by that route, as the plunger 42 is depressed.

Conversely, as the plunger 42 rises again under the force of the spring 55, the liquid chamber 26 is primed in the conventional way via the inlet valve 35. Air flows in to occupy the air chamber 61 by downward displacement of the air inlet valve 80 relative to its valve seat under the prevailing pressure difference. Air flows into the air chamber 61 from cap air apace inside the cap shroud 45 that encloses the inlet valve 80. In turn, air may enter the cap air space via channel clearances between channels of the air piston insert sleeve 90 and the bottom rim of the cap shroud 45. Alternatively, air may enter the cap shroud 45 via an upper opening in the shroud itself, the air piston sleeve 90 being connected air tightly.

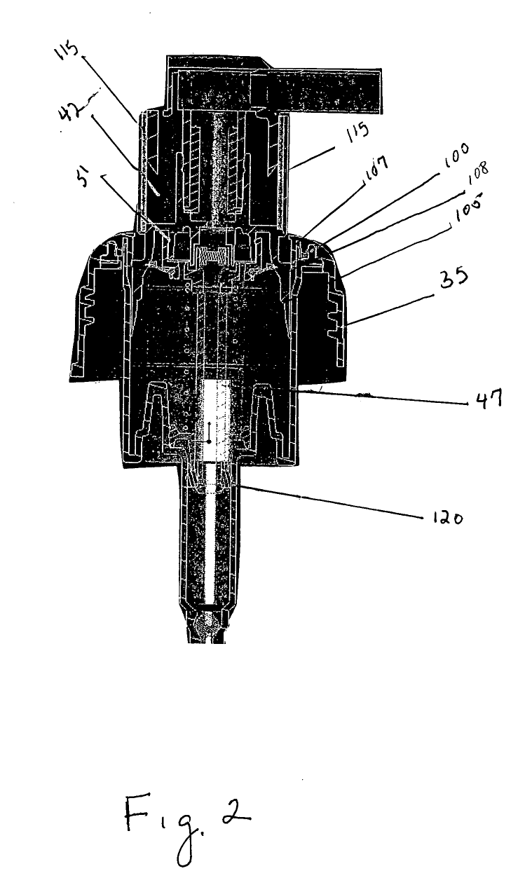

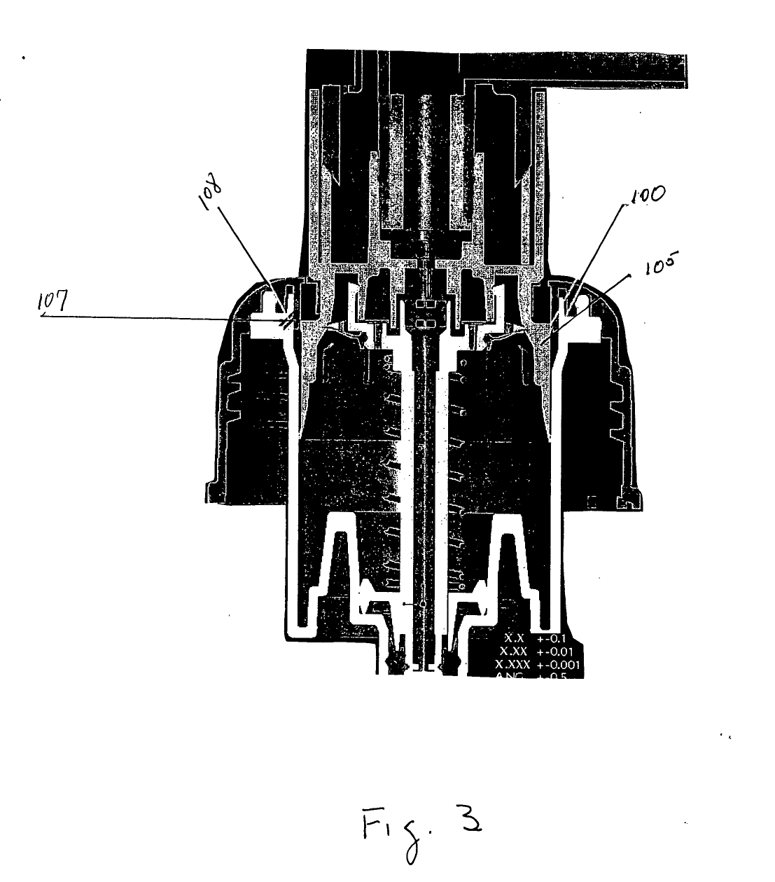

The dispenser 1 further includes a seal 100, also referred to as an up-lock seal. The seal 100 is located on the collar 35. The seal 100 may comprise a sealing ring as shown in the drawings. Alternatively the seal 100 can be any sort of seal. The seal 100 can be integrally formed with the collar 35 or can be connected therewith through a subsequent procedure. The seal 100 is airtight and liquid tight, substantially preventing air or liquid from entering or exiting the dispenser 1. The geometry of the seal 100 is such that it along with the surface finish and the material properties of such cause expansion under compression. More specifically, the seal 100 has an inclined plane shaped wall 105 (as shown in FIGS. 2 and 3) that contributes to expansion under compression. Further, the collar 35 and the bottle 10 and all components thereof are made of polypropylene co-polymer. The polypropylene co-polymer expands and shrinks in a reasonably consistent and predictable manner that accurately seals itself. This further contributes to the accurate expansion under compression.

The required compression is provided by the action a cam 107 pulling the plunger 42 into the seal 100. During operation, the seal 100 acts as a valve 108 that opens and closes by actuating (or more specifically, rotating) the spout 57/plunger 42 assembly. When the plunger 42 is rotated, it creates an interference fit that causes the valve 108 to close. Alternatively, the plunger 42 could be lifted to create an interference fits that causes the valve 108 to close. In particular, this interference condition results from expanding the seal 100 outward as the cam pulls the plunger 42 into the seal 100. The expansion of the seal 100 increases its diameter to create a solid interference fit between the body of the container 10, the collar 35, and the plunger 42. At its maximum expansion, a high stress condition is created and acts positively to close off the air passage and seal the liquid inside the container 10. Conversely, once the spout 57/plunger 42 assembly is actuated to the operational state, the interference is removed, and the seal 100 collapses in size sufficiently to positively open the valve 108 sufficiently to allow air to vent into the container 10.

The seal 100 further includes a chamfer or a radius. The chamfer/radius assists in guiding and forcing the plunger 42 to slide into the seal 100. On the other hand, a squared-off surface on the seal 100 will act as a catch. This will place a significant load on the plunger that can cause the plunger 42 to become out of square. If this condition occurs, the plunger air seal gets damaged and the entire foaming dispenser will be rendered useless and inoperable.

The operation of the seal 100 may be assisted by the use of two semi-circular segments 117 on the collar 35. These semi-circular segments 117 act as a squaring standoff. This holds the plunger 42 tight and square in the uplock state as well as acting as a bearing surface for the plunger 42 as it is activated. Further, the collar 35 includes two protrusions 104, 107. The two protrusions 104, 107 engage two cam keys 115 that are located within the plunger 42. Alternatively, any number of protrusions and cam keys can be used herewith, e.g., one, three, etc. Additionally, the number of protrusions need not necessarily match the number of cam keys. In the current embodiment one cam key is bigger than the other, although they could also be of the same size. This assists functions to align the plunger 42 and dispenser head properly, especially during operation of the dispenser 1. The two cam keys 115 engage the protrusions 104 and 107 to set the dispenser 1 in a locked position or an operational position. Further, the cam keys 115 of different sizes prevent the dispenser 1 from being assembled backward. Alternatively, two keys of equal size can be used if the application does not require key alignment. One of the keys can be a partial length of the other provided they both pull evenly in the locked position.

The dispenser 1 of the present invention seals both liquid and air then converts to open a vent using an air lock that opens and can be re-sealed by twisting the top of the plunger shaft to the locked position. Further, the dispenser 1 provides a foaming dispenser or foamer with a valve that can be opened and closed by the position of the seal. The valve prevents vacuum build-up inside a mating liquid bottle as liquid is pumped out. Finally, the dispenser can be placed in a locked position so that the plunger cannot be accidentally depressed. This is especially useful when the dispenser is transported to prevent accidental release of the liquid contained therein.

The invention has been described above and, obviously, modifications and alternations will occur to others upon a reading and understanding of this specification. The claims as follows are intended to include all modifications and alterations insofar as they come within the scope of the claims or the equivalent thereof.

Having thus described the invention, we claim:

1. A foam dispenser comprising:
a container;
a cylinder device;
a collar connected to said cylinder device, said collar operably connecting said container
with said cylinder device; and
a seal located on said collar, wherein said seal expands under compression to a locked position to create an airtight and liquid tight seal substantially preventing air and liquid from entering or exiting said cylinder device.

2. The foam dispenser of claim 1, wherein said seal comprises a sealing ring connected to said collar.

3. The foam dispenser of claim 2, wherein said sealing ring is integrally formed on said collar.

4. The foam dispenser of claim 1, wherein said cylinder device includes a plunger, at least a portion of said plunger is mounted within said cylinder device.

5. The foam dispenser of claim 4, wherein said seal includes a cam wherein said compression is provided by action of said cam pulling said plunger into said seal.

6. The foam dispenser of claim 5, wherein said seal acts as a valve that opens and closes by actuating said plunger.

7. The foam dispenser of claim 6, wherein said plunger is actuated by rotating said plunger to cause said cam to lift said plunger upward toward said seal.

8. The foam dispenser of claim 7, wherein pulling said plunger into said seal creates an interference fit that causes said valve to close to said locked position.

9. The foam dispenser of claim 8, wherein said interference fit results from expanding said seal outward as said cam pulls said plunger into said seal.

10. The foam dispenser of claim 9, wherein expansion of said seal increases its diameter to create said interference fit between said container, said collar, and said plunger to create an airtight and liquid tight seal substantially preventing air or liquid from entering or exiting said cylinder device or said container.

11. The foam dispenser of claim 10, wherein actuating said plunger to an operational position removes said interference fit causing said seal to collapse sufficiently to positively open said valve to allow air to vent into said container.

12. The foam dispenser of claim 11, wherein said seal includes at least one of a chamfer and a radius.

13. The foam dispenser of claim 12, wherein either of said chamfer and radius assist in pulling said plunger into said sealing ring.

14. The foam dispenser of claim 13, further comprising at least one squaring off device located on said collar to hold said plunger tight and square in said locked position as well as acting as a bearing surface for said plunger as it is activated.

15. The foam dispenser of claim 14, wherein said collar includes at least one protrusion and said plunger includes at least one cam key, wherein said cam key engages said protrusion to set said foam dispenser in said locked position or said operational position.

16. The foam dispenser of claim 15, wherein said collar includes two protrusions and said plunger includes two cam keys of different sizes to prevent said dispenser from being assembled backward.

17. A foam dispenser comprising:
a container;
a cylinder device;
a collar connected to said cylinder device to operably connect said container with said cylinder device;
a plunger, at least a portion of which is mounted within said cylinder device; and
a seal located within said collar and engageable with said plunger, wherein said seal is capable of being opened to vent said cylinder device and said container and capable of being closed to substantially prevent air or liquid from entering or exiting said cylinder device.

18. The foam dispenser of claim 17, wherein said seal is capable of creating an interference fit between said container, said collar, and said plunger to create an airtight and liquid tight seal substantially preventing air or liquid from entering or exiting said cylinder device.

19. The foam dispenser of claim 18, wherein said seal includes a cam.

20. The foam dispenser of claim 19, wherein said seal creates said interference fit by expanding outward as said cam pulls said plunger into said seal.

21. The foam dispenser of claim 20, wherein actuating said plunger causes said cam to pull said plunger into said seal and causes said seal to expand outward.

22. A foam dispenser comprising:
a container;
a cylinder device;
a collar connected to said cylinder device, said collar operably connecting said container with said cylinder device;
a plunger, wherein at least a portion of said plunger is mounted within said cylinder device; and
a seal located on said collar, said seal comprising:
an inclined wall; and
a cam capable of engaging said plunger with said inclined wall to substantially prevent air or liquid from entering or exiting said cylinder device.

23. The foam dispenser of claim 21, wherein said seal acts as a valve that opens and closes by actuating said plunger to cause said cam to lift said plunger into said seal.

24. The foam dispenser of claim 23, wherein pulling said plunger into said seal creates an interference fit between said container, said collar, and said plunger by expanding said seal causing said valve to close to a locked position creating an airtight and liquid tight seal substantially preventing air or liquid from entering or exiting said cylinder device or said container.

25. The foam dispenser of claim 24, wherein actuating said plunger to an operational position removes said interference fit by causing said seal to collapse sufficiently to positively open said valve to allow air to vent into said container.
